(19) United States
(12) Patent Application Publication
(10) Pub. No.: US 2006/0139280 A1
(43) Pub. Date: Jun. 29, 2006

(54) Pixel structure of a low color shift liquid crystal display (LCD) panel, a driving method, and a fabrication method thereof

(75) Inventors: Jenn-Jia Su, Budai Township (TW); Ming-Feng Tien, Tainan City (TW); Ming-Chou Wu, Nan Tou Hsien (TW); Po-Lun Chen, Chia Yi City (TW)

Correspondence Address: BRUCE H. TROXELL, SUITE 1404, 5205 LEESBURG PIKE, FALLS CHURCH, VA, 22041, US

(73) Assignee: AU Optronics Corp.

(21) Appl. No.: 11/315,377

(22) Filed: Dec. 23, 2005

(30) Foreign Application Priority Data
Dec. 24, 2004 (TW) 93140568

(51) Int. Cl. G09G 3/36

(52) U.S. Cl. 345/95

(57) ABSTRACT

A pixel structure of a liquid crystal display (LCD) panel including an upper substrate, a lower substrate, an LC layer, and a common electrode layer is provided. The LC layer is interposed between the upper substrate and the lower substrate. The common electrode layer is formed on a lower surface of the upper substrate and has at least a separating structure to divide the common electrode layer into several zones including a first zone and a second zone applied with different common voltage levels within a pixel structure.

### BACKGROUND OF THE INVENTION

(1) Field of the Invention

This invention relates to a pixel structure of a liquid crystal display (LCD) panel, and more particularly to the color shift event of the LCD panel.

(2) Description of the Related Art

FIG. 1 shows a cross-section view of a typical LCD panel. As shown in FIG. 1, the LCD panel has an upper substrate 120, a lower substrate 220, and an LC layer 300. A color filter 140, a common electrode layer 160, and a first aligning film 180 are formed on a lower surface of the upper substrate 120 in a serial. A pixel electrode layer 260 and a second aligning film 280 are formed on an upper surface of the lower substrate 220 in a serial. The LC layer 300 is sandwiched between the first aligning film 180 and the second aligning film 280. A driving field is generated in the LC layer 300 by charging the pixel electrode layer 260 and the common electrode layer 160 so as to change the orientation of the LC molecules for adjusting the amount of retardation.

In FIG. 1, a light beam L1 traveling perpendicular to the upper substrate 120 and a light beam L2 traveling with a tilt angle of θ degree in respect to the light beam L1 are described. It is understood that the angles between the light beam L1 and the optical axis of the LC molecules as well as the light beam L2 and the optical axis are different. Thus, the two light beams L1 and L2 leaving the LCD panel are engaged with retardation events, which influence image intensity and also result in the formation of color shift event.

For a better understanding of the color shift event, there shows a diagram in FIG. 2 depicting gamma curves at the view points with various tilt angles θ in regard of a traditional vertical aligned (VA) LCD. The X axis of the diagram represents the bit number assigned by the driving circuit of the LCD. The Y axis of the diagram represents the optical transmission of the LC layer 300. It is noted that all the gamma curves (the gamma curves with the tilt angles of 0°, 15°, 30°, 45°, and 60° as shown) have a left end, which represents to the greatest bit number (the bit number 255), assigned with an optical transmission of 1. That is, these gamma curves represent relative brightness with respect to the image under the greatest bit number.

Generally, the image at the viewing point normal to the LCD panel, which has a tilt angle of 0°, represents the color closest to the case of ideal gamma curve, which shows the true colors. Whereas, the gamma curves at the view point with certain tilt angles must have some bias in respect to the ideal gamma curve. In addition, the greater the tilt angle is, the greater the separation between the present gamma curve with respect to the ideal gamma curve is resulted. Thus, the image at the view point with a large tilt angle has severe color shift event and badly affects the imaging quality of the LCD panel.

Accordingly, it has become an important issue to solve the problem of color shift event, which is demanded for the improvement of LCD panel's viewing angle.

### SUMMARY OF THE INVENTION

It is an object of the present invention to provide a method for solving the problem of color shift event, which occurs especially at the view point with large tilt angles.

A pixel structure of an LCD panel is provided in the present invention. The pixel structure comprises an upper substrate, a lower substrate, an LC layer, and a common electrode layer. The lower substrate is located under the upper substrate. The LC layer is interposed between the two substrates. The common electrode layer is formed on a bottom surface of the upper substrate and has at least a separating structure dividing the common electrode layer into at least a first zone and a second zone. The first zone and the second zone are applied with a first voltage level and a second voltage level respectively.

A method for improving the color shift event of the LCD panel is also provided in the present invention. The method is to apply at least two different common voltage levels to a common electrode layer and have the duration of each frame divided into at least a front portion and a rear portion applied with the different common voltage levels.

### BRIEF DESCRIPTION OF THE DRAWINGS

The present invention will now be specified with reference to its preferred embodiment illustrated in the drawings, in which:

FIG. 1 is a schematic cross-section view depicting a conventional liquid crystal display (LCD) panel;

FIG. 2 shows the gamma curves with various tilt angles in regard of a conventional vertical aligned (VA) LCD panel;

FIG. 3 is a schematic cross-section view depicting a preferred embodiment of the pixel structure of an LCD panel in accordance with the present invention;

FIG. 4 is a flow chart depicting a preferred embodiment of the fabrication method for the pixel structure as shown in FIG. 3;

FIG. 5a shows a preferred embodiment of the waveforms of the pixel voltage, the first common voltage, and the second voltage applied to the pixel structure of FIG. 3;

FIG. 5b shows another preferred embodiment of the waveforms of the pixel voltage, the first common voltage, and the second voltage applied to the pixel structure of FIG. 3;

FIG. 6 is a top view depicting a preferred embodiment of the common voltage layer in respect to the pixel structure of FIG. 3;

FIG. 7 is a top view depicting another preferred embodiment of the common voltage layer in the pixel structure of FIG. 3;

FIG. 8a is a diagram depicting the relationship between the optical transmission of the portions in the illumination region of the pixel structure with respect to the first zone and the second zone as shown in FIG. 3 and the driving voltage;

FIG. 8b shows the gamma curves at the view points with a large tilt angle and a small tilt angle respectively as the first zone and the second zone having an area size ratio 10:0;

FIG. 8c shows the gamma curves in respect to the pixel structure of FIG. 6 as the first zone and the second zone having an area size ration 4:6;

FIG. 9 is a top view depicting one another preferred embodiment of the common voltage layer in the pixel structure of FIG. 3;

FIG. 10a is a diagram depicting the relationship between the optical transmission of the portions in the illumination region of the pixel structure with respect to the first zone, the second zone, and the third zone as shown in FIG. 9 and the driving voltage;

FIG. 10b shows the gamma curves in respect to the pixel structure of FIG. 9 as the first zone, the second zone, and the third zone having an area size ration 3:4:3;

FIG. 11 is a cross-section view depicting another preferred embodiment of the pixel structure of the LCD panel in accordance with the present invention;

FIG. 12 shows the waveform of a preferred embodiment of the common voltage signal utilized for improving color shift event in accordance with the present invention; and

FIG. 13 shows the waveform of another preferred embodiment of the common voltage signal utilized for improving color shift event in accordance with the present invention.

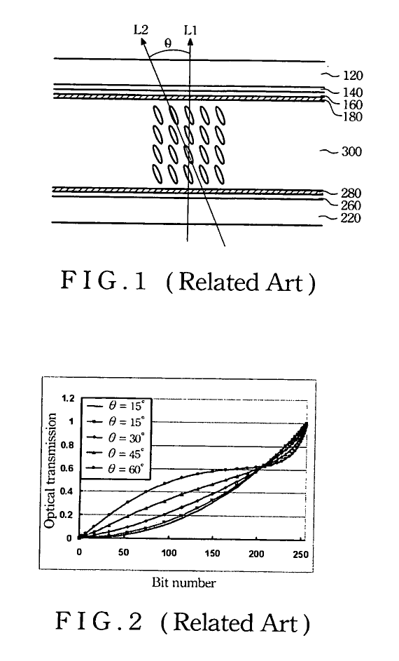

### DESCRIPTION OF THE PREFERRED EMBODIMENTS

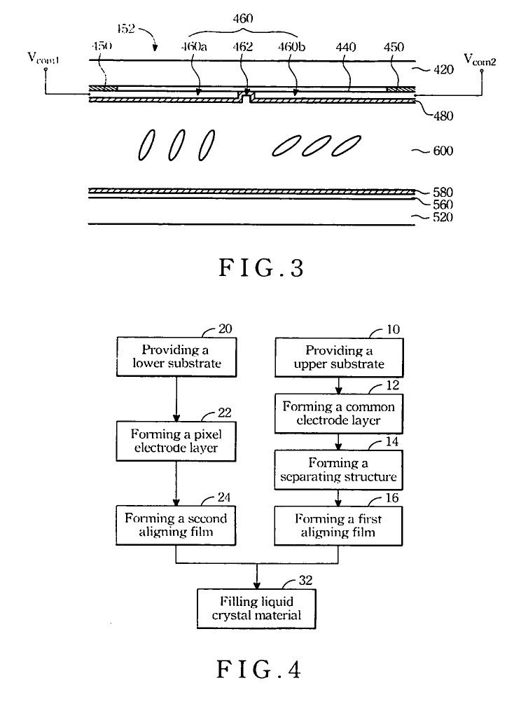

FIG. 3 shows a preferred embodiment of a pixel structure of an LCD panel in accordance with the present invention. As shown, the pixel structure has an upper substrate 420, a lower substrate 520, and an LC layer 600. The lower substrate 520 is located under the upper substrate 420. The LC layer 600 is interposed between the upper substrate 420 and the lower substrate 520.

A black matrix (BM) 450, a common electrode layer 460, and a first aligning film 480 are formed on a bottom surface of the upper substrate 420 in a serial. The opening 452 of the BM 450 identifies the illumination region within the pixel structure. A color filter 440 is filled into the opening 452 to define the illumination color of the pixel structure. A pixel electrode layer 560 and a second aligning film 580 are formed on an upper surface of the lower substrate 520 in a serial. The LC molecules within the LC layer 600, which may be the twisted nematic (TN) type, the super twisted nematic (STN) type, or the vertical aligned (VA) type LC molecules, are guided by the first aligning film 480 and the second aligning film 580 to show predetermined tilt angles. The pixel electrode layer 560 and the common electrode layer 460 are utilized for generating driving fields in the LC layer 600 to change the orientation of the LC molecules for adjusting the optical transmission of the pixel structure.

A slit 462 is formed crossing the common electrode layer 460 on the bottom surface of the upper substrate to divide the common electrode layer 460 into a first zone 460a and a second zone 460b. The first zone 460a and the second zone 460b are applied with a first common voltage signal V_{com1} and a second common voltage signal V_{com2}, which are assigned with different common voltage levels, respectively. In addition, as a preferred embodiment, the first zone 460a or the second zone 460b should occupy larger than or equal to 25% of the surface area of the common electrode layer 460. That is, the neighboring first zone 460a and the second zone 460b should have an area size ratio ranging between about ⅓ to about 3.

FIG. 4 shows a flow chart depicting a preferred embodiment of a fabrication method of the pixel structure in FIG. 3. In the fabrication steps 10˜16 in regard to the upper substrate 420, the common electrode layer 460 is firstly formed on the bottom surface of the upper substrate 420. Afterward, at least a separating structure, such as the slit 462 shown in FIG. 3, is formed in the common electrode layer 460 to divide the common electrode layer 460 into a plurality of separated zones (the first zone 460a and the second zone 460b are shown) applied with different common voltage levels. Afterward, the first aligned film 480 is formed on the common electrode layer 460.

In the fabrication steps 20˜24 in regard to the lower substrate 520, the pixel electrode layer 560 is firstly formed on the upper surface of the lower substrate 520. Afterward, the second aligning film 580 is formed on the pixel electrode layer 560. After finishing the above mentioned steps, in the fabrication step 32, the upper substrate 420 is assembled on the lower substrate 520 with LC material injected between the two substrates 420,520 to complete the pixel structure. The step of filling LC material between the two substrates 420 and 520 can be achieved by dropping LC material on the upper substrate 420 or the lower substrate 520 before the assembling step 32, which is understood as one drop fill (ODF) method.

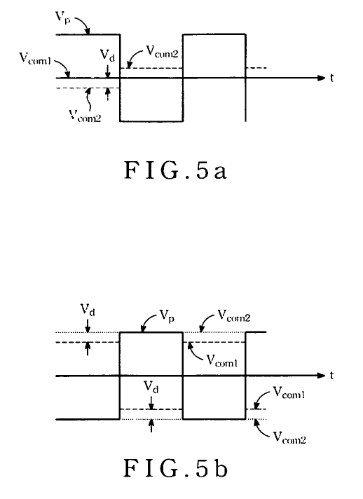

FIG. 5a shows a preferred embodiment of the waveforms of the pixel voltage signal Vₚ, the first common voltage signal V_{com1}, and the second common voltage signal V_{com2} applied on the pixel structure of FIG. 3. The first common voltage signal V_{com1} has a constant voltage level. Whereas, both the second common voltage signal V_{com2} and the pixel voltage signal Vₚ have alternative voltage levels showing positive and negative biases in respect with the first common voltage signal V_{com1}. In addition, the potential difference V_{d} between the second common voltage signal V_{com2} and the first common voltage signal V_{com1} remains constant.

It should be noted that in FIG. 5a, the potential difference between the pixel voltage signal Vₚ and the second common voltage signal V_{com2} is greater than the potential difference between the pixel voltage signal Vₚ and the first common voltage signal V_{com1}. Thus, referring to FIG. 3, the driving field generated in the LC layer 600 below the second zone 460b is greater than that below the first zone 460a. Due to the difference of driving fields, the LC molecules under the first zone 460a and the second zone 460b shows different tilt angles.

FIG. 5b shows another preferred embodiment of the waveforms of the pixel voltage signal Vₚ, the first common voltage signal V_{com1}, and the second common voltage signal V_{com2} applied on the pixel structure of FIG. 3. In compared with the embodiment of FIG. 5a, the present embodiment has both the first common voltage signal V_{com1} and the second common voltage V_{com2} in the present embodiment showing alternative voltage levels. However, the potential difference V_{d} between the second common voltage V_{com2} and the first common voltage V_{com1} still remains constant.

In addition, the waveforms of FIGS. 5a and 5b teach that the first common voltage signal V_{com1} and the second common voltage signal V_{com2} applied to the first zone 460a and the second zone 460b are performed simultaneously or at least in the same frame.

FIG. 6 is a top view showing a preferred embodiment of the pixel structure of FIG. 3 in accordance with the present invention. As show, a slit 462 crosses the common electrode layer 460 to divide the common electrode layer 460 into strip-shaped first zone 460a and second zone 460b, which are applied with different voltage levels. The illumination region of the pixel structure, which is defined by the opening 452 of the BM 450, aligns to the pixel electrode layer (not shown in this figure) and can be divided into two portions with respect to the two zones 460a,460b of the common electrode layer 460 showing different optical transmission.

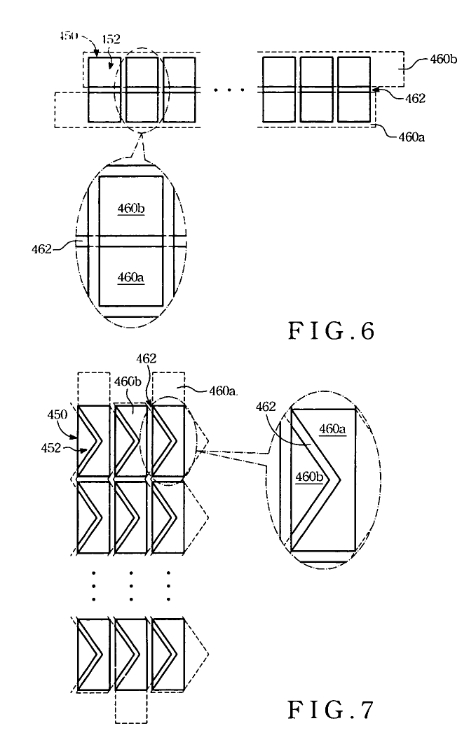

FIG. 7 is a top view showing another preferred embodiment of the pixel structure of FIG. 3 in accordance with the present invention. In compared with the embodiment of FIG. 6, the slit 462 crossing the common electrode layer 460 to form the first zone 460a and second zone 460b has some torts. The two zones 460a,460b are applied with different voltage levels to have the illumination region, which is defined by the opening 452 of the BM 450, divided into two portions with respect to the two zones 460a,460b showing different optical transmission.

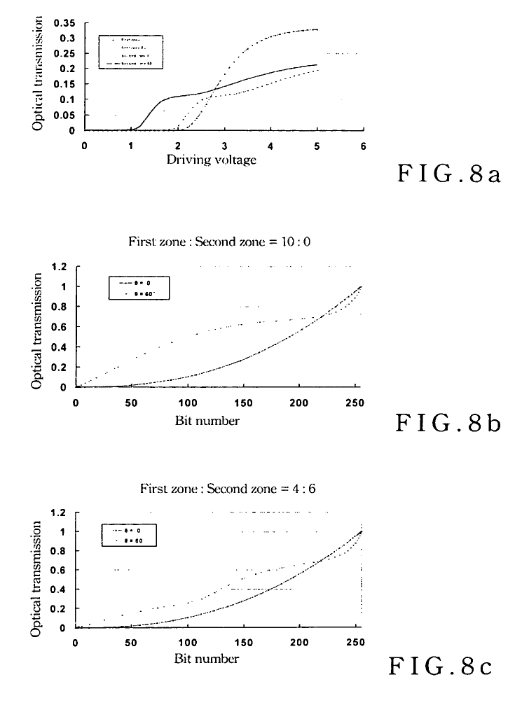

FIG. 8a shows the relationship between the optical transmission of the pixel structure and the driving voltage with only the first common voltage signal V_{com1} or the second common voltage signal V_{com2} being applied, which can also be regarded as depicting the portions in the illumination region with respect to the first zone 460a and the second zone 460b of FIG. 3, respectively. FIGS. 8b to 8d depict the optical transmission of the pixel structure at the view points with a large tilt angle (the tilt angle of 60 degree) and a small tilt angle (the tilt angle of 0 degree) according to the data provided in FIG. 8a. In FIG. 8b, the pixel structure with the first zone and the second having an area size ratio 10:0 is described, which may be regarded as the case of traditional LCDs with only one common voltage level being applied. It is noted that the gamma curve at the view point with the large tilt angle deviates away from the ideal gamma curve at the view point with the tilt angle of 0 degree significantly. Thus, a severe color shift event is unpreventable.

FIG. 8c shows the gamma curves with respect to the case of FIG. 6. In addition, the area size ratio of the first zone 460a and the second zone 460b in FIG. 6 is set to be 4:6. In compared with the gamma curves of FIG. 8b, the gamma curve at the view point with the large tilt angle is closer to the ideal gamma curve at the view point with the tilt angle of 0 degree in the present embodiment. Thus, the color shift event can be effectively promoted and the viewing angle of the LCD panel can be increased thereby.

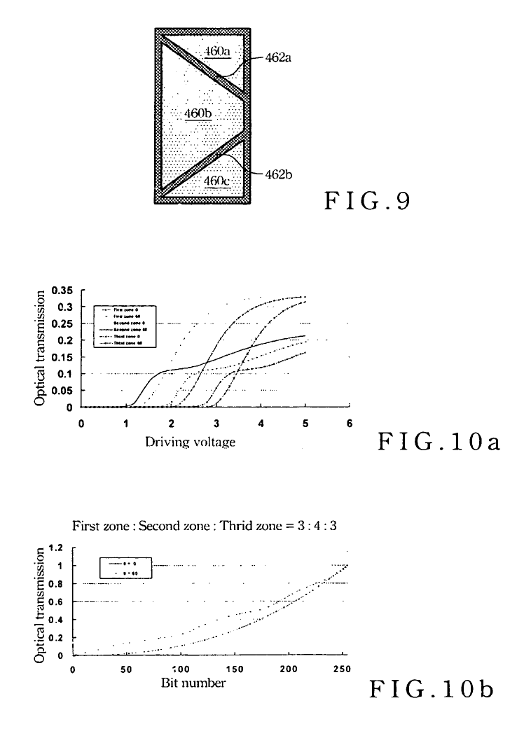

Although the cases of FIGS. 6 and 7 have the common electrode layer 460 being divided into the first zone 460a and the second zone 460b applied with two different common voltage levels. The number of zones being formed are not a limitation in the present invention. As shown in FIG. 9, the common electrode layer 460 within the pixel structure can be divided into three zones, the first zone 460a, the second zone 460b, and the third region 460c by using two slits 462a, 462b. The three zones 460a,460b,460c may be applied with two or three different common voltage levels according to the need. In the case of three different common voltage levels being applied, the illumination region of the pixel structure can be divided into three portions with respect to the three regions 460a,460b,460c showing different optical transmission, respectively.

FIG. 10a shows the relationship of the optical transmission of the three portions in the illumination region with respect to the first zone 460a, the second zone 460b, and the third zone 460c in FIG. 9, respectively, and the driving field. FIG. 10b shows case that the area size ratio of the first zone 460a, the second zone 460b, and the third region 460c of FIG. 9 is set to be 3:4:3. In compared with the gamma curves of FIG. 8c, the gamma curve at the view point with the tilt angle of 60 degree in present embodiment is closer to the ideal gamma curve at the view point with the tilt angle of 0 degree. Thus, the color shift event can be further promoted.

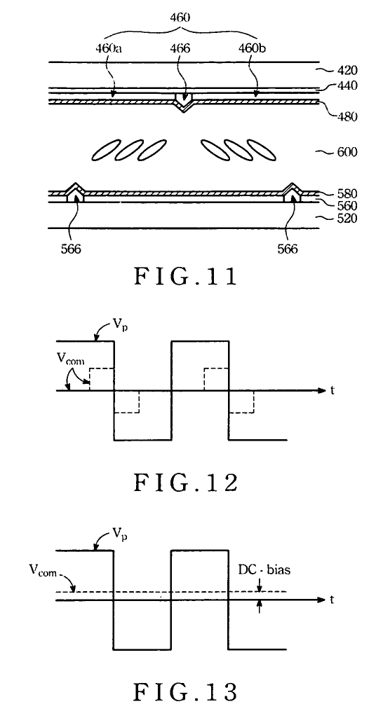

FIG. 11 is a cross-section view depicting another preferred embodiment of the pixel structure in accordance with the present invention. In compared with the embodiment of FIG. 3, which uses the silt 462 as the separating structure, a protrusion 466 is formed by filling dielectric material into the slit 462 for dividing the common electrode layer 460 into the first zone 460a and the second zone 460b. The pixel electrode layer 560 also has some protrusions 566. The protrusions 466,566 in the common electrode layer 460 and the pixel electrode layer 560 facilitate to control the orientation of the LC molecules within the LC layer 600. Also referring to the fabrication method of FIG. 4, the protrusions 566 may be formed after step 22, the formation of the pixel electrode layer 560, and before step 24, the formation of the second aligning film 580. Although the LC molecules as shown are vertical aligned (VA) type LC molecules, typical twisted nematic (TN) type or super twisted nematic (STN) type LC molecules still can be used in the present invention.

As mentioned, the protrusions 466,566 facilitate to control the orientation of the LC molecules. It is understood that the slits 462 as shown in FIG. 3 may be formed in the common electrode layer 460 or the pixel electrode layer 560 to facilitate to control the orientation of LC molecules also.

The above mention embodiments are characterized with zoning common electrode layer 460 and applying at least two common voltage signals to achieve the object of promoting color shift event. In the embodiment shown in FIG. 12, a method characterized with a single common voltage signal V_{com} having a predetermined waveform is provided. Basically, the alteration of the pixel voltage signal Vₚ respects to the frames. The common voltage signal V_{com} in the present embodiment has the section with respect to one single frame being divided into a front portion and a rear portion. The two portions are applied with two different voltage levels. As shown, the front portion has a voltage level lower than the rear portion. Since the two portions within the section respects to a single pixel voltage level, two driving fields with different strength are generated in the LC layer one after another in the duration one single frame last.

As mentioned, two images having different common voltage levels are provided in the duration one single frame last. Since human eyes have the limitation of recognizing the fast switching of images, the combination of the two different images may be felt instead. Therefore, it is predictable that the present embodiment has a displaying result similar to the embodiment of FIG. 3, in which a mixture of images with different driving fields are simultaneously performed. In addition, since FIG. 8c teaches that a significant improvement may be achieved by setting the area size ratio of the first zone and the second zone being 4:6, it is also suggested that the length ratio of the front portion and the rear portion being set between 4:6 and 6:4.

In compared with the embodiment of FIG. 12, which characterized with the common voltage signal V_{com} having a predetermined waveform to improve the color shift event, another embodiment shown in FIG. 13 characterized with a constant common voltage signal V_{com} instead. As shown, by shifting the level of the common voltage signal to generate a DC-bias, the diving fields of the frame with positive polarity and the frame with negative polarity are different. Thus, a mixture of the frames with positive and negative polarity may be felt, and a result similar to the embodiment in FIG. 12 can be achieved to improve the color shift event and increase the viewing angle.

While the embodiments of the present invention have been set forth for the purpose of disclosure, modifications of the disclosed embodiments of the present invention as well as other embodiments thereof may occur to those skilled in the art. Accordingly, the appended claims are intended to cover all embodiments which do not depart from the spirit and scope of the present invention.

We claim:

1. A pixel structure of a liquid crystal display (LCD) panel, comprising:
an upper substrate;
a lower substrate located under the upper substrate;
a pixel electrode layer formed on an upper surface of the lower substrate;
a common electrode layer, formed on a bottom surface of the upper substrate, having at least a separating structure dividing the common electrode layer into at least a first zone and a second zone having different voltage levels applied therein; and
a liquid crystal (LC) layer sandwiched between the upper substrate and the lower substrate.

2. The pixel structure of claim 1, further comprising a first alignment layer formed on the common electrode layer.

3. The pixel structure of claim 2, further comprising a second alignment layer formed on the pixel electrode layer.

4. The pixel structure of claim 1, wherein the separating structure is a slit.

5. The pixel structure of claim 1, wherein the separating structure is a protrusion.

6. The pixel structure of claim 1, further comprising a black matrix (BM) layer interposed between the common electrode layer and the upper substrate.

7. The pixel structure of claim 1, wherein the pixel electrode layer has at least one protrusion.

8. The pixel structure of claim 1, wherein the area of the first zone is larger than or equal to a quarter of the area of the common electrode layer.

9. The pixel structure of claim 1, wherein the ratio of the area of two neighboring zones ranges from about ⅓ to about 3.

10. A method for improving color shift of a liquid crystal display (LCD), comprising:
applying a first common voltage level to a pixel structure of the LCD; and
applying a second common voltage level to the pixel structure, wherein the first common voltage level and the second voltage level are different.

11. The method of claim 10, wherein the step of applying the first common voltage level comprises applying the first common voltage level to a first zone in the pixel structure, and the step of applying the second common voltage level comprises applying the second common voltage level to a second zone in the pixel structure.

12. The method of claim 10, further comprising applying a pixel voltage level to the pixel structure.

13. The method of claim 12, wherein the difference between the first common voltage level and the pixel voltage level is greater than that between the second common voltage level and the pixel voltage level.

14. The method of claim 10, wherein the difference between the second voltage level and the first voltage level is a constant.

15. The method of claim 10, wherein the step of applying the first common voltage level and the step of applying the second common voltage level are performed in a frame.

16. The method of claim 10, wherein the step of applying the first common voltage level and the step of applying the second common voltage level are performed simultaneously.
